(19) United States
(12) Patent Application Publication
(10) Pub. No.: US 2023/0115198 A1
(43) Pub. Date: Apr. 13, 2023

(54) RECEPTACLE WITH BAG LINER DISPENSER

(71) Applicant: simplehuman, LLC, Torrance, CA (US)

(72) Inventors: Guy COHEN, Marina del Rey, CA (US); Jay PATEL, Buena Park, CA (US); Yan Pui CHAN, Alhambra, CA (US); Joseph MEEK, Lake Balboa, CA (US); Joseph SANDOR, Newport Beach, CA (US)

(21) Appl. No.: 18/045,594

(22) Filed: Oct. 11, 2022

Related U.S. Application Data
(60) Provisional application No. 63/262,407, filed on Oct. 12, 2021.

(51) Int. Cl. B65F 1/06

(52) U.S. Cl. CPC B65F 1/062; B65F 2210/168

(57) ABSTRACT

The present disclosure describes a receptacle assembly having receptacle body and a bag liner dispenser connected to the receptacle body. The bag liner dispenser has a biasing member, a magnet, and a sensor. The assembly can have an electronic control unit configured to communicate with the sensor and determine an estimated number of liner bags remaining in the bag liner dispenser at least in part based on one or more characteristics of a magnetic field emitted by the magnet. A network communication device can be connected to the electronic control unit and configured to provide information to a user about bag liners.

### REFERENCE TO RELATED APPLICATIONS

This application claims the benefit of U.S. Provisional Application No. 63/262,407, filed Oct. 12, 2021. This application hereby incorporates by reference the above-identified provisional application in its entirety.

The entire contents of U.S. Patent Publication No. 2015/0251849, filed on Mar. 4, 2015, and U.S. Patent Publication No. 2019/0014954, filed on Sep. 18, 2018, are also hereby incorporated by reference for all that they disclose.

### BACKGROUND

### Field of the Invention

This disclosure relates generally to receptacle assemblies, and particularly in some embodiments to trash can assemblies with bag liners.

### Description of the Related Art

Receptacles for holding waste (e.g., trash, recycling, compost, etc.) often employ disposable bag liners for containing the waste, for easily removing waste from the receptacle, and for preventing the waste from contaminating the receptacle. A user sequentially uses bag liners until the supply is exhausted. Once the supply is exhausted the user replaces the bag liners.

### SUMMARY

In conventional receptacles, the bag liners are not easily accessible. For example, the bag liners may be stored in a location spaced away from the receptacle, such as in a closet or under a sink. This can make it inconvenient to access a replacement liner and/or can increase the chance of a user forgetting to insert a replacement liner in the receptacle. As a result, the receptacle may be left without a bag liner for an extended period of time. During that time, waste may be thrown directly into the receptacle, thus contaminating the receptacle.

In some embodiments, a receptacle assembly comprises a body portion comprising a front wall, a rear wall, and lateral side walls connecting the front wall and the rear wall, the body portion further comprising an upper edge and a lower edge. The receptacle assembly can comprise a bag liner dispenser configured to receive bag liners and an opening that provides access to the bag liners when the bag liners are positioned in the bag liner dispenser. The receptacle assembly can include an electronic controller, a biasing member configured to urge the bag liners toward the opening when the bag liners are positioned in the dispenser, a magnet and a sensor. The controller can be configured to provide information about the bag liners remaining in the dispenser by calculating the position of the biasing member by detecting changes in or characteristics of a magnetic field emitted by the magnet based on relative movement or distance between the sensor and the magnet.

In some embodiments, a combination of the assembly and bag liners are provided. In some embodiments, the biasing member comprises a first bend. In some embodiments, a middle portion of the first bend is closer to the rear wall of the body portion than the rear wall of a housing of the bag liner dispenser. In some embodiments, the magnet is positioned in a recess of the biasing member. In some embodiments, the biasing member is coupled to a rod, wherein the rod is coupled to a housing of the bag liner dispenser. In some embodiments, the biasing member further comprises a second bend. In some embodiments, the sensor is configured to generate a signal to enable the controller to determine the number of bag liners within the bag liner dispenser.

In some embodiments, a receptacle assembly comprises a receptacle body and a bag liner dispenser coupled to the receptacle body. The bag liner dispenser can comprise a housing, a biasing member positioned within the housing and rotatably coupled to a rod, a magnet coupled to the biasing member, and a sensor configured to detect changes in the magnetic field based on a position of the basing member.

In some embodiments, the biasing member comprises a first bend. In some embodiments, a middle portion of the bend is closer to the rear wall of the receptacle body than a rear wall of the housing of the bag liner dispenser. In some embodiments, the magnet is positioned in a recess of the biasing member. In some embodiments, the biasing member further comprises a second bend. In some embodiments, a controller in electronic communication with the sensor is configured to determine the number of bag liners within the bag liner dispenser.

In some embodiments, a receptacle assembly comprises a receptacle body, a bag liner dispenser coupled to the receptacle body, an electronic control unit connected to the sensor and powered by a power supply, and a network communication device connected to the electronic control unit. The bag liner dispenser can include a biasing member, a magnet, and a sensor. The electronic control unit can be configured to communicate with the sensor, and determine, upon receiving a signal from the sensor, an estimated amount of liner bags remaining in the bag liner dispenser based at least in part on one or more characteristics of the magnetic field emitted by the magnet. The network communication device can be configured to transmit, to a computing system separate from the receptacle assembly, a notification providing information to a user about bag liners.

In some embodiments, the biasing member comprises a first bend. In some embodiments, a middle portion of the bend is closer the rear wall of the receptacle body than the rear wall of the housing of the bag liner dispenser. In some embodiments, the magnet is positioned in a recess of the biasing member. In some embodiments, the biasing member is coupled to a rod, wherein the rod is coupled to a housing. In some embodiments, the biasing member further comprises a second bend. In some embodiments, the network communication device notifies a user to refill the bag liner dispenser.

### BRIEF DESCRIPTION OF THE DRAWINGS

FIG. 1A illustrates a rear perspective view of an example of a receptacle assembly having a bag liner dispenser.

FIG. 1B illustrates an enlarged, rear perspective view of the receptacle assembly shown in FIG. 1A with a lid portion and a rear cover of the bag liner dispenser not shown for purposes of presentation.

FIG. 1C illustrates an enlarged, front perspective view of the receptacle assembly shown in FIG. 1A with a lid portion not shown for purposes of presentation.

FIG. 2 illustrates a rear perspective view of another example of a receptacle having a bag liner dispenser.

FIG. 3A illustrates a rear perspective view of an interior container having a bag liner dispenser.

FIG. 3B illustrates a front perspective view of the interior container shown in FIG. 3A.

FIG. 4A illustrates a cross-section of another bag liner dispenser having a biasing member and a package of bag liners disposed within the bag liner dispenser.

FIG. 4B illustrates a cross-section of another example of a bag liner dispenser having a biasing member.

FIG. 4C illustrates a front perspective view of the biasing member shown in FIG. 4B.

FIG. 5 illustrates a side section view of a receptacle assembly with a bag liner dispenser.

FIG. 6A illustrates the bag liner dispenser of FIG. 5 removed from the receptacle body.

FIG. 6B illustrates the bag liner dispenser of FIG. 6A with the inner wall and biasing member removed.

FIG. 7A illustrates a perspective section view of the bag liner dispenser of FIG. 6A having a biasing member, sensor, and magnet.

FIG. 7B illustrates a rear view of the receptacle assembly of FIG. 5 with the housing of the bag liner dispenser removed.

FIG. 8 is a block diagram depicting an example of an illustrative network environment in which a domestic appliance communications system may operate.

FIG. 9A is a logical flow diagram of an embodiment of a process for providing domestic appliance status information remotely to a user computing device, involving the receptacle assembly of FIG. 5.

FIG. 9B is a logical flow diagram of an embodiment of a process for providing domestic appliance status information remotely to a user computing device, involving the domestic appliance communication system of FIG. 8.

### DETAILED DESCRIPTION

Various bag liner dispensers are described below to illustrate various examples that may be employed to achieve one or more desired improvements. These examples are only illustrative and not intended in any way to restrict the general inventions presented and the various aspects and features of these inventions. Furthermore, the phraseology and terminology used herein is for the purpose of description and should not be regarded as limiting. No features, structure, or step disclosed herein is essential or indispensable. All sizes and proportions illustrated in the accompanying figures form part of this specification and are intended to be utilized as examples and to provide support for any claims that specifically refer to such illustrated sizes or proportions, but should not be considered as limiting the scope of this specification.

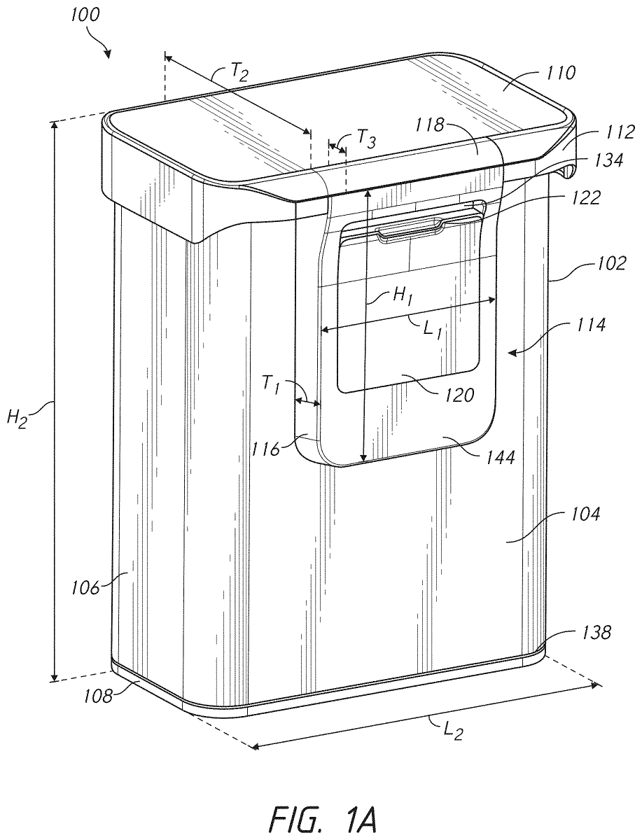

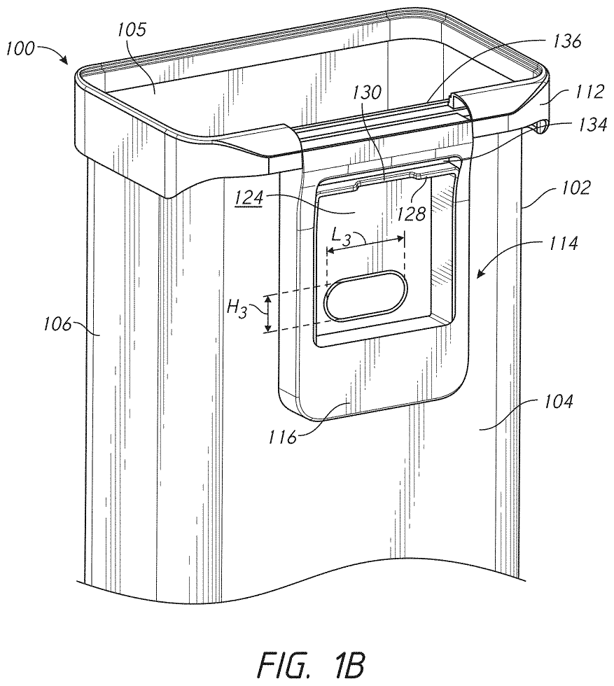

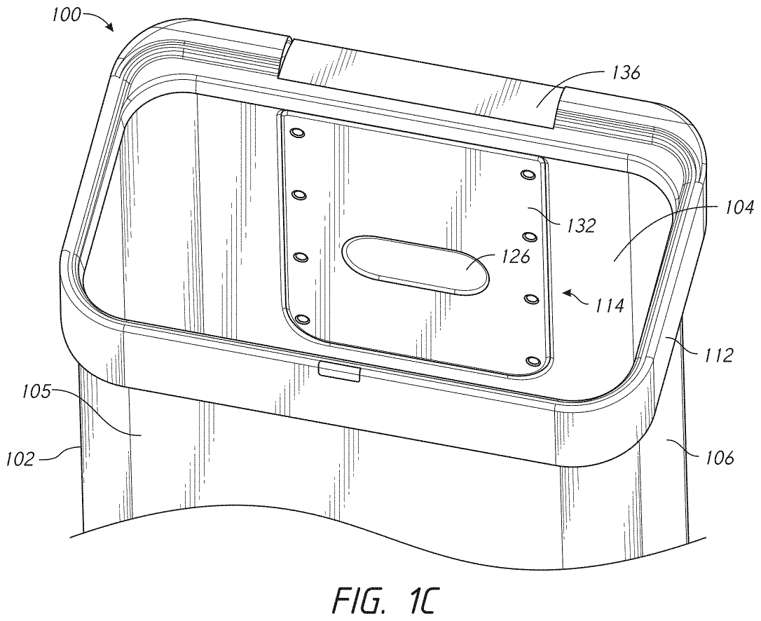

FIGS. 1A-1C illustrate a receptacle assembly 100 having a body portion 102, a base portion 108, and a lid portion 110 movable with respect to the body portion 102. The base portion 108 can support the receptacle assembly 100 in a stable, resting position when the receptacle assembly 100 rests on a surface such as a floor, and the body portion 102 can extend upward from the base portion 108. In some embodiments, the base portion 108 can be formed of a plastic material and/or can comprise a skirt or foundation that extends generally all of the way around the receptacle 100, from the ground to the bottom of the body portion 102. Although not shown, the receptacle assembly 100 can include a mechanism to move the lid portion 110 from a closed to an open position, such as a pedal-operated mechanism or a sensor-activated mechanism. Additional information regarding sensor-activated mechanisms can be found in U.S. Publication No. 2011/0220647, filed Mar. 4, 2011, titled “Trash Can With Power Operated Lid,” which is hereby incorporated by reference in its entirety. Any features, structure, or step disclosed and/or illustrated in the '674 application can be utilized in combination with or instead of any features, structure, or step disclosed and/or illustrated in this specification.

The body portion 102 can include a front wall 105, a rear wall 104, and lateral sidewalls 106 connecting the front wall 105 and the rear wall 104. If the lid portion 110 is pivotably connected (e.g., rotatably, hingedly, or otherwise) to the body portion 102, the rear wall 104 can be on the same side as the pivotable connection between the lid portion 110 and the body portion 102. The body portion 102 can comprise an upper edge 136 and a lower edge 138. The lid portion 110 can be disposed along or near the upper edge 136 of the body portion 102, and the base portion 108 can be disposed along or near the lower edge 138 of the body portion 102. Although FIGS. 1A-1C illustrate a generally rectangular body portion 102, the body portion 102 can be generally cylindrical or any other shape. Any of the receptacle assembly 100 components can be formed from one or more different materials, such as sheet metals (e.g., sheet stainless steel or aluminum), other metals, plastics, and/or other materials. For example, the body portion 102 can include a 23 to 26 gauge (i.e., a thickness between about 0.0179 inches and 0.0269 inches) stainless sheet shell.

In some embodiments, to help provide a generally open, generally unobstructed, generally even distribution of contents (e.g., waste) inside of the bag liner, an interior surface of the body portion 102 can have a generally smooth, generally continuous, and/or generally unobstructed surface that extends entirely or substantially entirely across the interior surface of the body portion 102 from the upper edge 136 of the body portion 102 to the lower edge 138 of the body portion 102 (see FIG. 1C). In some embodiments, the interior surface of the body portion 102 can be free of substantial bumps, protrusions, recesses, and/or other features that produce appreciable unevenness (e.g., greater than or equal to about 5 mm change in a dimension generally perpendicular to a plane parallel to the interior surface).

Various embodiments of the receptacle assembly 100 can include an upper trim member 112 coupled to the lid portion 106 (see FIGS. 1A-1C). The trim member 112 can comprise a plastic or metal edge, border region, or otherwise, generally positioned at or near a top portion of the receptacle assembly 100. The trim member 112 can be pivotably coupled (e.g., rotatably, hingedly, or otherwise) with the body portion 102. When the trim member 112 is in a closed position, the trim member 112 can engage the upper edge 136 of the body portion 102.

As discussed above, in some scenarios, bag liners may not be easily accessible, which may result in the receptacle assembly being without a bag liner for an extended period of time. During that time, waste may be thrown directly into the receptacle assembly, thus contaminating the receptacle assembly. Accordingly, it can be desirable to provide the receptacle assembly 100 with a bag liner dispenser 114, such that the bag liners are conveniently located and easily accessible. The bag liner dispenser 114 can be configured to receive and to dispense one or more bag liners (e.g., a package of bag liners), but the term “bag liner dispenser” does not require the presence of bag liners therein at all times. For example, the portion of a waste receptacle that can be configured to receive a package of bag liners can be considered a “bag liner dispenser” even before the product has ever received bag liners or ever been used to dispense bag liners.

FIGS. 1A-1C illustrate an embodiment of the bag liner dispenser 114. As shown, the dispenser 114 can be secured to the rear wall 104 of the body portion 102, such that multiple bag liners can be stored in the bag liner dispenser 114, disposed exterior to the rear wall 104 prior to use. In some variants, the dispenser 114 is positioned on the exterior of the front wall 105 or on one of the sidewalls 106. Such exterior configurations can maintain an interior volume of the receptacle assembly 100. Positioning the bag liner dispenser 114 on a front, side, or rear wall of the body portion 102 can avoid a reduction in a depth of the interior volume without increasing an overall height of the receptacle assembly 100. In some embodiments, positioning the bag liner dispenser 114 exterior to the rear wall 104 leaves the interior surface of the rear wall 104 generally smooth, generally planar (e.g., positioned generally vertically), generally continuous, and/or generally unobstructed (e.g., free of any substantial bumps, protrusions, recesses, and/or other discontinuous features). This can avoid a reduction of the interior volume of the body portion 102 and/or reduce the chance that a bag liner disposed within the receptacle assembly 100 will be torn by the bag liner dispenser 114. Additionally, positioning the bag liner dispenser 114 on a rear wall 114 of the receptacle assembly 100 keeps the bag liner dispenser 114 out of plain sight when the rear wall 104 is positioned against a wall (e.g., wall of a house, building, or other structure) and avoids creating an obstruction to people or pets walking past the receptacle assembly 100.

As illustrated, by providing the bag liner dispenser 114 in an exterior region of the trash can, and/or near the top of the trash can, such as between a middle vertical region and a top region of a wall of the trashcan (e.g., rather than inside the trash can and/or at or near the bottom of the trash can), the user can more easily access bag liners without having to severely stoop over and/or the user can replenish bag liners from the outside of the trash can, without being required to remove a bag liner inside the trash can or other receptacle that may be partially filled with trash in order to access and replenish the bag liner dispenser with additional bag liners.

In some embodiments, as shown in FIG. 1C, the rear wall 104 can include an opening through which an interior wall 132 of the bag liner dispenser 114 can be inserted. In some embodiments, a portion (e.g., the inner wall 132) of the bag liner dispenser 114 can be coupled to an exterior surface of the rear wall 104. In certain embodiments, at least a portion of the bag liner dispenser 114 can be integrally formed with the body portion 102, such that a wall portion of the body portion 102 forms a part of the bag liner dispenser 114.

In some embodiments, the bag liner dispenser 114 can generally include a housing 116 with an interior volume 124 in which one or more bag liners (not shown) can be disposed. The bag liner dispenser 114 can include a dispenser lid 120 removably or movably (e.g., rotatably, hingedly, or otherwise) connected to the housing 116. The dispenser lid 120 can include a user-grip portion 122 (e.g., groove, handle, or otherwise), such that the dispenser lid 120 can be easily moved between an open position and a closed position. In some embodiments, as shown in FIG. 1A, the housing 116 can have an opening 134 (e.g., channel, groove, indentation, or likewise) near the user-grip portion 122 so that the user can easily grasp the user-grip portion 112. Further, as shown in FIG. 1B, the housing 116 can include a support member 128 that can engage the dispenser lid 120 when the dispenser lid 120 is in the closed position. For example, the dispenser lid 120 can form a snap connection with a groove 130 of the support member 128.

In some embodiments, the housing 116 can include a rear cover 144. In some embodiments, the rear cover 144 is separately formed from a portion of the housing 116. FIG. 1B illustrates the bag liner dispenser 114 with the rear cover 144 removed. As shown in FIG. 1A, the rear cover 144 can extend from a lower edge of the bag liner dispenser 114 to an upper edge of the bag liner dispenser 114. The rear cover 144 can include an upper portion 118 that extends over the upper edge 136 of the body portion 102. For example, as shown in FIG. 1A, the upper portion 118 can wrap around at least a portion of the upper edge 136 (see FIG. 1B) of the body portion 102 (or the trim member 112, lid portion 110, or any other component at or near the upper edge 136 of the body portion 102). The upper portion 118 can be disposed between the ends of the trim member 112 and can be generally aligned (e.g., substantially flush) with a rear portion of the trim member 112.

As shown in FIGS. 1B and 1C, an opening 126 can be formed in the interior wall 132 of the bag liner dispenser 114 and/or the rear wall 104 of the body portion 102 (e.g., when the bag liner dispenser 114 is integrally formed with the body portion 102). The opening 126 can provide access from an interior volume 124 of the bag liner dispenser 114, through the rear wall 104, to an interior space of the body portion 102. As shown in FIG. 1B, the opening 126 can be generally oblong. A length L₃ of the opening 126 can be greater than a height H₃ of the opening 126, such as at least two times greater or at least three times greater than the height H₃ of the opening 126. In some embodiments, the area of the opening 126 is substantially less than the upper main opening into the interior space of the body portion 102 around which the upper edge 136 extends (e.g., less than or equal to about one-tenth of the area of the main opening).

The opening 126 provides the user with easy access to the bag liners. For example, when the bag liner dispenser 114 is positioned on the rear wall 104 of the body portion 102 and the rear wall 104 is positioned against a wall (e.g., a wall of a house, building, or other structure), a user can, from within the receptacle, extract a bag liner from the dispenser 114 via the opening 126. This can avoid the need to move the receptacle assembly 100, such as if the opening was disposed along a rear surface of the bag liner dispenser 114.

The bag liner dispenser 114 and the opening 126 can be positioned closer to the upper edge 136 of the body portion 102 than the lower edge 138 of the body portion 102. For example, the opening 126 can be formed in the upper half or upper quarter of the rear wall 104. This can put the bag liners in a convenient location. For example, in this configuration, the user can easily access a first bag of the plurality of bags and each subsequent bag without having to bend over and/or extend their arm too far into the receptacle assembly 100. In some embodiments that include an interior rigid waste container (not shown), the opening 126 can be located vertically above the level of the top of the waste container so as not to block the opening 126 by the inner waste container. In some embodiments, an opening in the inner waste container can permit access to the dispenser 114 through both the opening in the outer surface of the receptacle assembly 100 and the opening in the waste container.

In certain implementations, it can be desirable to minimize the overall size occupied by the receptacle assembly 100 during operation. For example, it can be desirable for the receptacle assembly 100 to be able to operate generally flush against a wall (e.g., the wall in a house). In some embodiments, as shown in FIGS. 1A and 1B, a rear surface of the bag liner dispenser 114 (e.g., the rear cover 144 and/or housing 116) does not extend in a rearward direction beyond a rear edge of the trim member 112 (or a rear edge of the lid portion 110 or other rear edge of an upper portion of the receptacle assembly 100). To provide a generally low-profile receptacle assembly 100, the length L₁ and/or the height H₁ of the bag liner dispenser 114 can be substantially greater than the thickness T₁ of the bag liner dispenser 114. For example, the thickness T₁ can be less than or equal to about 50% of the length L₁ of the bag liner dispenser 114, preferably less than or equal to about 25% of the length L₁ of the bag liner dispenser 114, such as less than or equal to about 15% of the length L₁ of the bag liner dispenser 114. As another example, the thickness T₁ can be less than or equal to about 50% of the height H₁ of the bag liner dispenser 114, preferably less than or equal to about 25% of the height H₁ of the bag liner dispenser 114, such as less than or equal to about 15% of the height H₁ of the bag liner dispenser 114, or less than or equal to about 10% of the height H₁ of the bag liner dispenser 114.

In some embodiments, a thickness T₁ of the bag liner dispenser 114 can be less than or equal to a thickness T₃ of the trim member 112 (see FIG. 1A). In some embodiments, the thickness T₁ of the bag liner dispenser 114 can be less than or equal to about one-half the thickness T₂ of the body portion 102, such as less than or equal to about one-third the thickness T₂ of the body portion 102, preferably less than or equal to about one-fifth the thickness T₂ of the body portion 102. In some embodiments, the length L₁ of the bag liner dispenser 114 can be less than or equal to about 75% of the length L₂ of the body portion 102, preferably less than or equal to about 50% the length L₂ of the body portion 102. In some embodiments, the height H₁ of the bag liner dispenser 114 can be less than or equal to about 75% of the height H₂ of the body portion 102, such as less than or equal to about 50% the height H₂ of the body portion 102, preferably less than or equal to about 40% the height H₂ of the body portion 102.

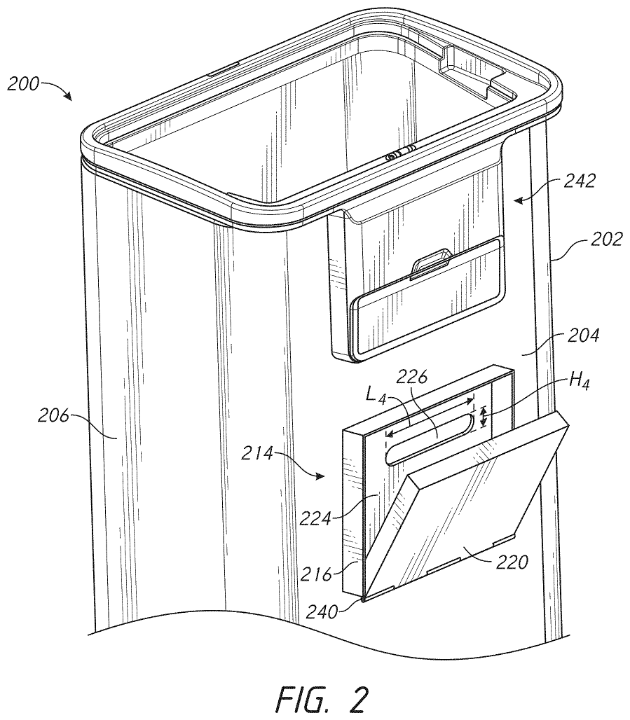

With reference to FIG. 2, another example of an embodiment of a receptacle assembly 200 having a bag liner dispenser 214 is shown. The bag liner dispenser 214 resembles or is identical to the bag liner dispenser 114 discussed above in many respects and can include any of the same desirable features or components as the bag liner dispenser 114. Accordingly, numerals used to identify features of the bag liner dispenser 114 are incremented by a factor of one hundred (100) to identify like features of the bag liner dispenser 214. This numbering convention generally applies to the remainder of the figures. Any structure, component, or step disclosed in any embodiment in this specification can be used in any other embodiments within the scope of this disclosure.

FIG. 2 illustrates a receptacle assembly 200 having a backside enclosure 242 that can house a power source for the receptacle assembly 200. The bag liner dispenser 214 can be positioned below the backside enclosure 242 on (e.g., secured to) the rear wall 204 of the receptacle assembly 200. The bag liner dispenser 214 can include dimensions that are the same as or similar to the bag liner dispenser 114. Further, the proportions between the bag liner dispenser 214 and the body portion 202 can be the same as or similar to the bag liner dispenser 114 and the body portion 102.

The bag liner dispenser 214 can include a housing 216 with an interior volume 224 in which one or more bag liners (not shown) can be disposed. Additionally, the bag liner dispenser 214 can include a dispenser lid 220 movably (e.g., rotatably, hingedly, or otherwise) connected to the housing 216. For example, as shown in FIG. 2, the dispenser lid 220 can rotate about a pivot member 240. In some embodiments, the dispenser lid 220 can be biased to a closed position, such as by a spring. When the dispenser lid 220 is in the closed position, the dispenser lid 220 can engage or interface with the housing 216.

As shown in FIG. 2, an opening 226 can be located in the rear wall 204 of the body portion 202. The opening 226 can provide access from an interior volume 224 of the bag liner dispenser 214 to an interior space of the body portion 202. In some embodiments, the opening 226 can be generally oblong. A length L₄ of the opening 226 can be greater than a height H₄ of the opening 226, such as at least two times greater or at least three times greater than the height H₄ of the opening 226. In certain variants, the length L₄ of the opening 226 is less than or equal to the height H₄ of the opening.

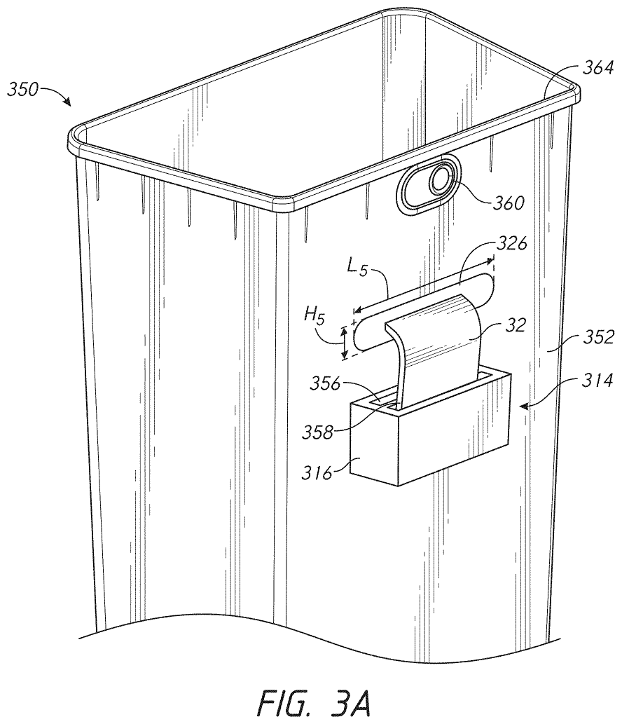

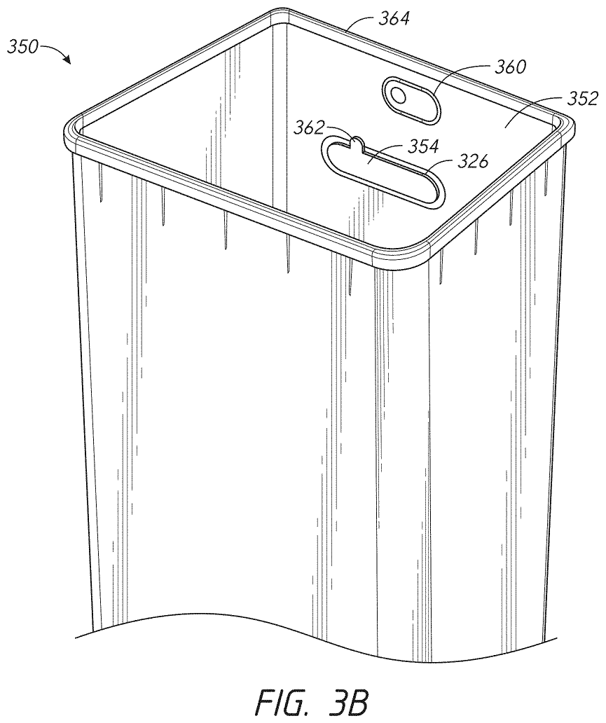

As mentioned above, some receptacles can include an interior metal or plastic liner that fits within the receptacle, which can be removed and washed. FIGS. 3A and 3B illustrate an illustrative interior container 350. As shown, the interior container 350 can have a bag-securing member 360. For example, a user can secure a bag liner in the bag-securing member 360 by pushing an upper portion of a bag liner into a portion of the bag-securing member 360 that can be configured to removably secure the bag, requiring greater force to remove the received portion of the bag from the bag-securing member 360 than would normally be exerted on the bag by the accumulation of waste therein.

In some embodiments, a bag liner dispenser 314 can be positioned between the interior container 350 and the body portion of a receptacle assembly (not shown) when the interior container 350 is positioned in the interior space of the body portion. For example, the bag liner dispenser 314 can be positioned on (e.g., secured to) the rear wall 352 of the interior container 350 (see FIG. 3A). In some embodiments, the dispenser 314 is positioned on an interior rear wall of the receptacle assembly and the interior container 350 has a recess configured to receive the dispenser 314 (not shown). The bag liner dispenser 314 can include dimensions similar to the bag liner dispenser 114. Further, the proportions between the bag liner dispenser 314 and the interior container 350 can be the same as or similar to the bag liner dispenser 114 and the body portion 102.

The bag liner dispenser 314 can include a housing 316 having an opening 356 for receiving a plurality of bag liners (not shown). The bag liner dispenser 314 can also include a biasing member 372 (e.g., a leaf spring, torsion spring, tension spring, compression spring, or otherwise). The biasing member 372 can be positioned in an opening 358 of the housing 316 or otherwise secured to the housing 316 (e.g., fixed to an outer surface of the housing 316). At least a portion of the plurality of bag liners can be positioned between the rear wall 352 of the interior container 350 and the biasing member 372. The biasing member 372 can be biased toward the rear wall 352 to maintain the position of the bag liners relative to the rear wall 352. In some embodiments, the biasing member 372 can be configured to bias packaging (e.g., a box) in which the bag liners are disposed.

As shown in FIG. 3A, an opening 326 can be positioned in the rear wall 352 of the interior container 350. The opening 326 can provide access from the bag liner dispenser 314 to an interior space of the interior container 350. In certain implementations, the opening 326 can be positioned closer to an upper edge 364 of the interior container 350 than a lower edge of the interior container 350. In some embodiments, the opening 326 can be generally oblong. A length L₅ of the opening 326 can be greater than a height H₅ of the opening 326, such as at least two times greater or at least three times greater than the height H₅ of the opening 326. FIG. 3B illustrates an interior view of the opening 326 with a tabbed portion 362 of the bag liner 354 extending through the opening 326. The tabbed portion 362 can be integrally formed with and include the same material as the remaining portion of the bag liner 354. The tabbed portion 362 of a bag liner 360 can be configured to extend outside of a package of one or more bag liners while the rest of the bag liner remains generally inside of the package. In certain variants, the tabbed portion 362 can be separately formed and attached to the remaining portion of the bag liner 354. The tabbed portion 362 can be configured to facilitate accessing a bag liner 354 from the bag liner dispenser 314. As with all features, structures, components, or steps disclosed in this specification, the tabbed portion 362 can be used with any embodiment in this specification.

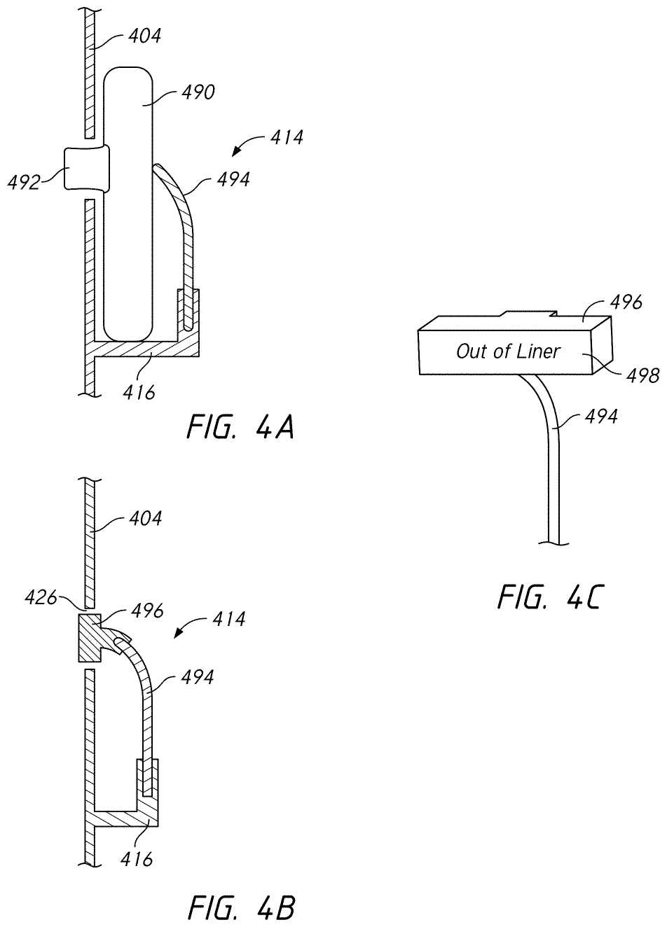

FIGS. 4A-4C illustrate another example of an embodiment of a bag liner dispenser 414 that can be used in connection with any of the receptacle assemblies and/or interior containers discussed herein. The bag liner dispenser 414 can include a housing 416 with an interior volume in which a package 490 of bag liners 492 can be disposed. The bag liner dispenser 414 can include a biasing member 494 (e.g., a leaf spring, torsion spring, tension spring, compression spring, or otherwise) secured to the housing 416. A package 490 of bag liners 492 can be positioned between the rear wall 404 of the receptacle assembly and the biasing member 494 and/or within the housing portion 416. The biasing member 494 can be biased toward the rear wall 404 to maintain the position of the bag liners 492 relative to the rear wall 404. For example, the biasing member 494 can encourage the bag liners to move generally toward the rear wall 404.

In some embodiments, as shown in FIGS. 4B and 4C, the biasing member 494 can include an end portion 496. The end portion 462 can be generally sized to fit within the opening 426 of the rear wall 404. A front face 498 of the end portion 496 can include a message, such as “out of liner,” or other indicator to indicate when the package 490 of bag liners 492 should be replaced.

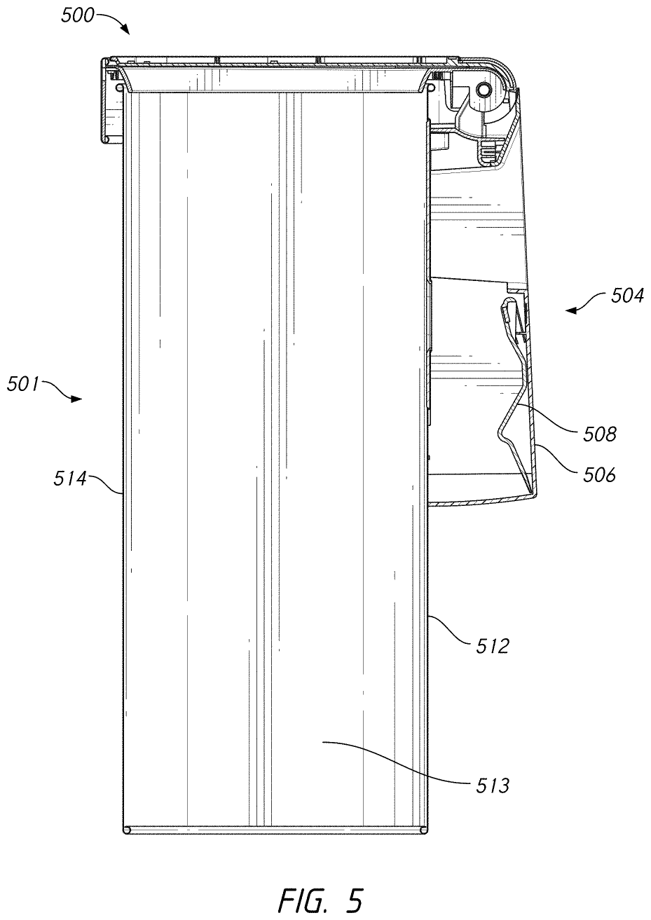

FIGS. 5-7B illustrate another example of an embodiment of a bag liner dispenser 504 that can be used in connection with any receptacle assemblies and/or interior containers, including those discussed herein. FIG. 5 shows a receptacle assembly 500 having a receptable 501 and a bag liner dispenser 504. The bag liner dispenser 504 can be coupled to the rear wall 512 of the receptacle 501. In some embodiments, the bag liner dispenser 504 can be coupled to a side wall 513 of the receptacle 501 or a front wall 514 of the receptacle 501. The bag liner dispenser 504 can have a housing 506. A biasing member 508 can be positioned within the housing 506.

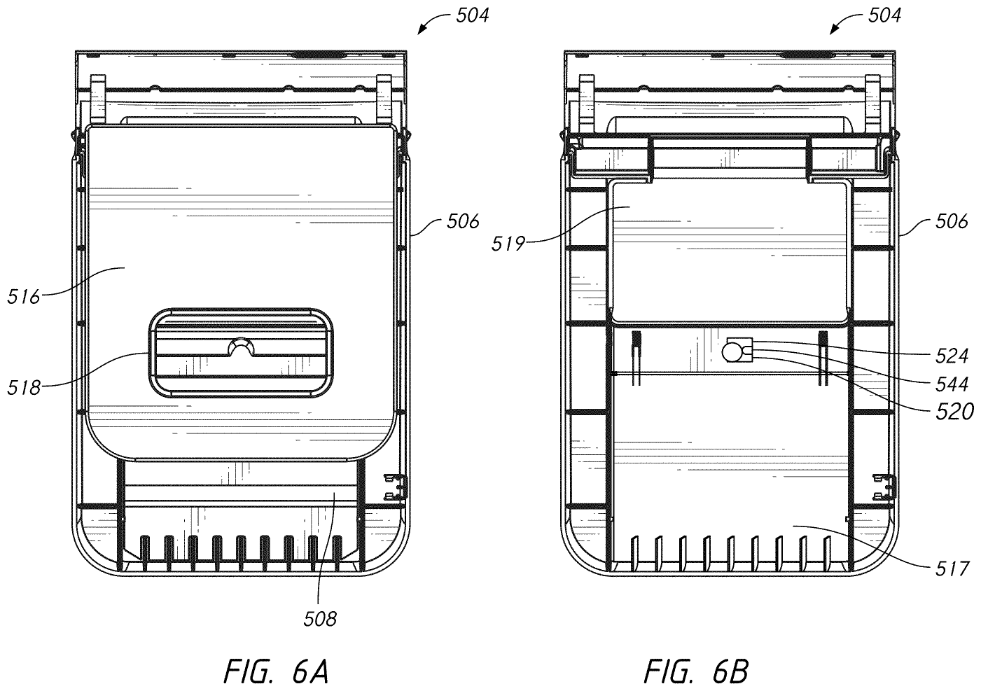

FIG. 6A shows the bag liner dispenser 504. The housing 506 of the bag liner dispenser 504 can have an inner wall or dispenser wall 516. The inner wall 516 can be coupled to the receptacle (e.g., receptacle 501). In some embodiments, the inner wall 516 can be a portion of the wall of the receptacle (e.g., the rear wall 512). The inner wall 516 can be the wall of the receptacle. In some embodiments, the inner wall 516 and the wall of the receptacle are different pieces.

The inner wall 516 can have an opening 518. The opening 518 can open into the bag liner dispenser 504 and into the receptacle 501. Bag liners can be positioned within the bag liner dispenser 504 and be pulled through the opening 518 and into the receptacle 501 for use. The opening 518 can be any shape, such as generally rectangular, circular, square, etc. As the amount of bag liners positioned within the bag liner dispenser 504 decreases, the biasing member 508 can be biased so as to move closer to the inner wall 516 and the receptacle 501. The biasing member 508 can assist the bag liners in moving closer and/or through the opening 518 and into the receptacle 501.

FIG. 6B shows the bag liner dispenser 504 with the inner wall 516 and the biasing member 508 removed. The housing 506 can have an opening 519 in the rear wall 517. The opening 519 opens to the outside of the bag liner dispenser 504 and can allow for a user to position bag liners within the bag liner dispenser 504. The opening 519 can be any shape for example square, rectangular, circular etc. The opening 519 can be sized to accept bag liners through it. The opening 519 can be positioned in a top portion of the rear wall 517 as shown. In some embodiments, the opening 519 can be positioned near the center of the rear wall 517. In some embodiments, the opening 519 can be positioned near the bottom of the rear wall 517.

The bag liner dispenser 504 can include a monitoring system for automatically detecting, measuring, calculating, estimating, storing, and/or communicating one or more characteristics of the consumable or disposable contents of the dispenser 504, such bag liners. The monitoring system can include an electronic controller or microprocessor, a memory, an electrical power source, one or more sensors, one or more mechanical transducers, and/or an electronic communicator.

In some embodiments, the monitoring system can be configured to detect information relating to and/or indicative of a remaining amount, volume, quantity, and/or number of bag liners that are positioned within or on the dispenser 504. For example, the monitoring system can include a detector for detecting information relating to a thickness of bag liner material that is generally positioned between a portion of the detector and the opening 519 in the rear wall 517 of the receptacle assembly 100. The detector can be configured to measure a variable position of a locator that is on or within the detector. Based upon the variable position of the locator and known information about the distance between the locator and the rear wall 517 of the receptacle assembly 100 that is stored in memory, the monitoring system can calculate the thickness of bag liner material remaining within the dispenser. Based upon this thickness, the monitoring system can calculate or estimate a number of bag liners remaining in the dispenser. The calculated or estimated number of bag liners remaining in the dispenser can be stored in memory, communicated electronically, and/or communicated to a user or directly to a supplier of bag liners such as through wireless media such as a local wireless network and/or the internet, through an electronic display, through a mobile electronic device, through one or more electronic audible sounds or voices, through one or more indicator lights, and/or through any other suitable communicating medium or device.

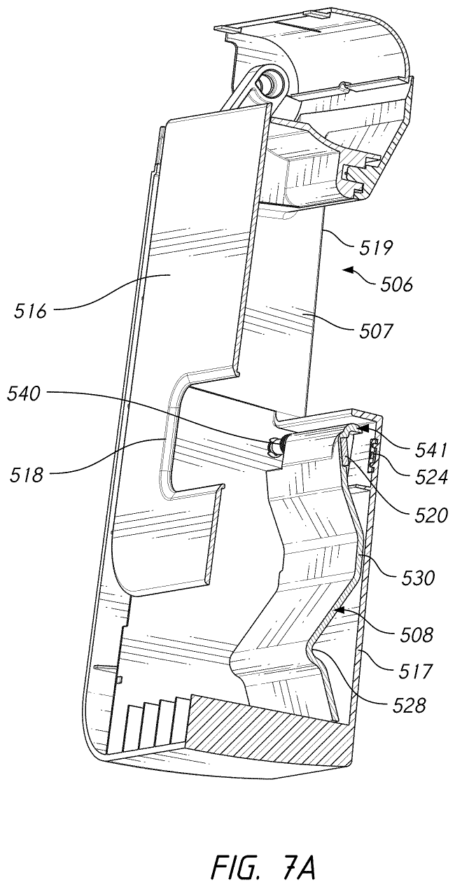

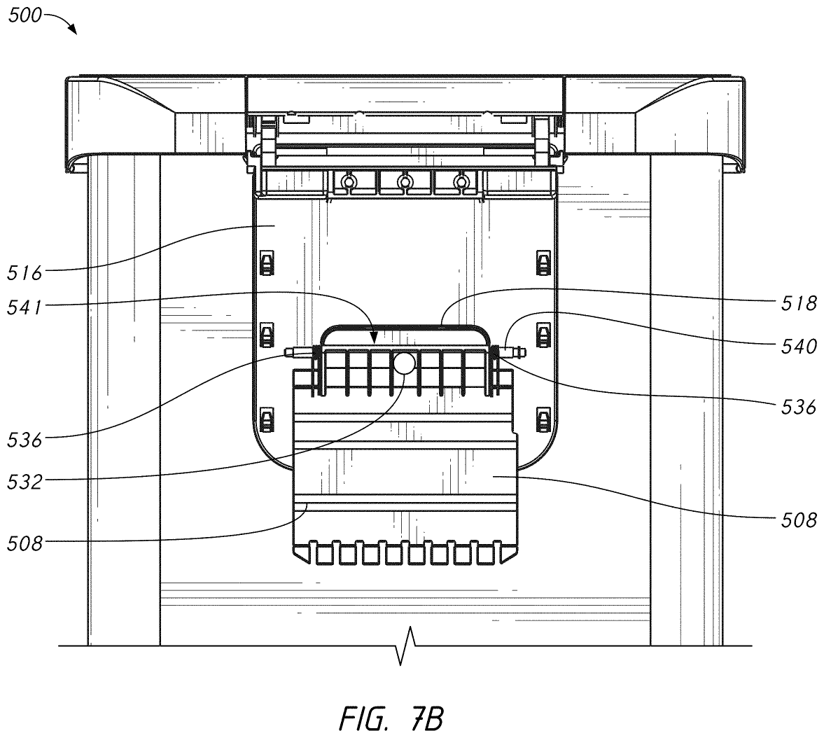

In some embodiments, the detector can comprise a locator in the form of a magnet 520 and/or a sensor 524. The magnet 520 can be positioned in a fixed location, such as on the rear wall 517. In some embodiments, the sensor can be positioned or coupled to a movable actuator such as the biasing member 508 (e.g., as shown in FIGS. 7A and 7B). In some embodiments, the magnet 520 may be movable with the biasing member 508 and the sensor 524 may be positioned in a fixed location. The electronic controller can be configured to estimate the location of the biasing member 508 using information provided by the sensor 524 about relative movement or distance between the sensor 524 and the magnet 520. The sensor 524 can be configured to transmit one or more electronic signals to the electronic controller that vary based upon the location of the biasing member 508 as measured by changes in or features of the magnetic field strength, and/or the density, magnitude, intensity, and/or direction of the magnetic flux that is emanating from the magnet and/or that is generally surrounding, around, above, and/or behind the biasing member 508 and magnet 520. The sensor 524 can be configured to measure the direction of the magnetic field. Any feature of the magnetic flux, such as the direction of the magnetic field, can change when the biasing member 508 and the magnet 520 rotate and/or move as the bag liners are dispensed and used. In some embodiments, the sensor can be a Hall effect sensor, or a high-sensitivity tunnelling magnetoresistance sensor, configured to provide stable magnetic operation over standard indoor room-temperature operating ranges (e.g., between about 60 to about 80 degrees Fahrenheit).

The magnet 520 and sensor 524 can be used to determine the amount of remaining bag liner material and thereby determine when the bag liners in the bag liner dispenser 504 need to be replaced or refilled. Additionally, the magnet 520 and the sensor 524 can be used to determine the number of bag liners remaining in the bag liner dispenser 504. In some embodiments, the electronic controller of the monitoring system can be configured to measure and store in memory the amount of bag liners that pass through and/or are withdrawn from a particular bag liner dispenser 504 over a particular time period, enabling the monitoring system to generally predict when in the future the remaining amount of bag liners will be consumed and need to be replaced. The monitoring system can provide this information to an electronic communicator (such as a wireless wifi communicator, a router, a modem, etc.) to provide information such as an alert or an offer to a user to purchase more bag liners and/or to provide this information directly to a supplier of bag liners.

FIG. 7A is a perspective section view of the bag liner dispenser 504. FIG. 7B is a rear view of the bag liner dispenser 504 with the housing 506 removed. The bag liner dispenser 504 can have a housing 506 and an inner wall 516. The housing can have sidewalls 507. The biasing member 508 can be positioned below the opening 519. A user can position bag liners through the opening 519 to sit between the biasing member 508 and the inner wall 516. The bag liners can then be pulled or pushed or moved through the opening 518 of the inner wall 516 to enter the receptacle (e.g., receptacle 501).

The biasing member 508 can be coupled to the housing 506 of the bag liner dispenser 504. In some embodiments, the biasing member 508 can be coupled to a rod 540. The rod 540 can extend the width of the biasing member 508. The biasing member 508 can be coupled to the rod 540 at a first end 541 of the biasing member 508. In some embodiments, the biasing member 508 can be coupled to rod 540 via one or more biasers such as springs 536. The springs 356 can apply a force on the biasing member 508. For example, the springs 356 can urge the biasing member 508 towards the inner wall 516 to advance or move the liner bags towards the opening 518.

The biasing member 508 can have a first portion or bend 530 that creates an acute angle or v-like shape in a portion of the biasing member 508. The base of the first bend 530 can be positioned closer to the rear wall 517 of the housing 506 than to the inner wall 516. In some embodiments, the bend 530 can have a truncated or generally flat middle portion. In some embodiments, the bend 530 can be rounded or curved. When the bag liner dispenser 504 is at full capacity and/or loaded with a new packet or roll of bag liners, the bend 530 can be positioned at a first distance from the rear wall 517 reflecting that the bend 530 is against, near, proximate, or adjacent to the rear wall 517. When the bag liner dispenser 504 is empty or near empty, the bend 530 can be positioned at a second distance from the rear wall 517 that is greater than the first distance from the rear wall 517. As a user uses the bag liners within the bag liner dispenser 517, the bend 530 moves further and further away from the rear wall 517.

The biasing member 506 can have a second portion or bend 528. The second bend 528 can create an acute angle or v-like shape. The base on the second bend 528 can be positioned closer to the inner wall 516 than to the rear wall 517 of the housing 506. In some embodiments, the bend 528 can have a truncated or generally flat middle portion. In some embodiments, the bend 528 can be rounded or curved. When the bag liner dispenser 504 is at full capacity, the bend 528 is positioned at its closest distance to the rear wall 517. When the bag liner dispenser 504, is empty or near empty, the bend 528 can be positioned at its shortest distance from the inner wall 516. As a user uses the bag liners within the bag liner dispenser 517, the bend 528 moves closer and closer to the inner wall 516. The bend 528 can apply a force to the bag liners positioned within the bag liner dispenser 504, urging and/or advancing the bag liners toward the opening 519 for convenient and access and removal by a user.

The biasing member 508 can have a retainer such as a recess 532. The recess 532 can be positioned at or near the first end 541 of the biasing member 508. The recess 532 can be sized and shaped to receive the magnet 520. The biasing member 508 can rotate relative to the rod 540 as the bag liners are removed individually through the opening 519. As the biasing member 508 rotates and moves closer to the inner wall 516, the relative position and/or orientation of the magnet 520 with respect to the sensor 524 can change. For example, relative movement, changes in relative orientation, and/or increase or decrease in distance, between the magnet 520 and the sensor 524 can create different magnetic fluxes and different directions of magnetic fields. One of more of the measurements of the magnetic flux and/or magnetic field can be used to determine how many liner bags remain and if a user needs to refill the bag liner dispenser 504. The sensor 524 can interact with an electronic control unit and network communication device.

The bag liner dispenser 504 of the receptacle assembly 500 (or the receptacle assembly itself) can be configured to measure consumption of consumable resources, such a bag liners. The bag liner dispenser 504 can include an electronic control unit (“ECU”) 544 (as shown in FIG. 6B). The ECU 544 can include one or a plurality of circuit boards providing a hard wired feedback control circuits, a processor and memory devices for storing and performing control routines, or any other type of controller. In an exemplary but non-limiting embodiment, the ECU 544 can include an H-bridge transistor/MOSFET hardware configuration which allows for bidirectional drive of an electric motor, and a microcontroller such as Model No. PIC16F685 commercially available from Microchip Technology Inc., and/or other devices. The ECU 544 can be connected to the sensor 524.

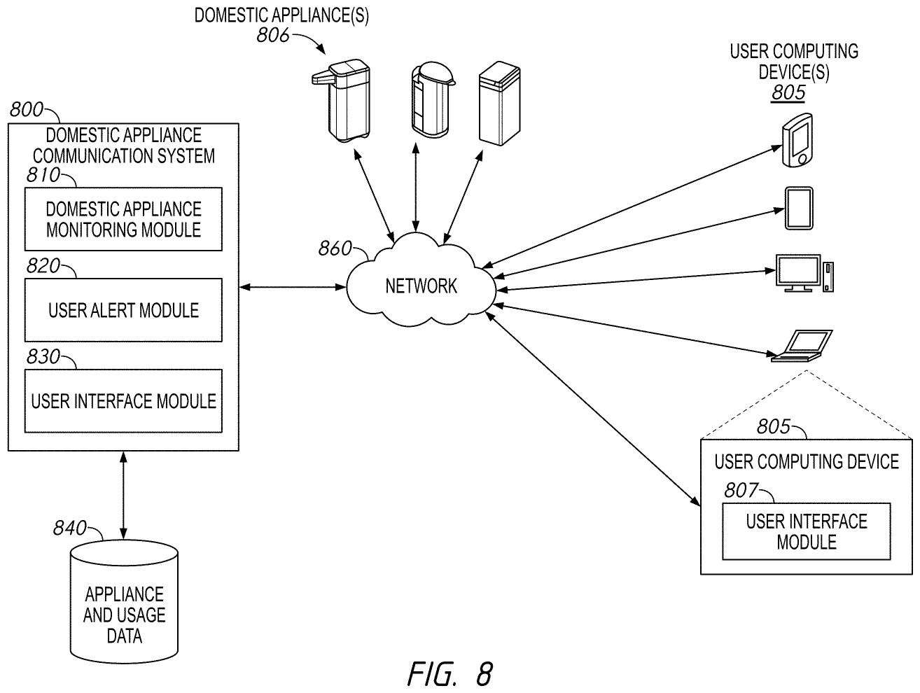

FIG. 8 is a general architecture diagram schematically illustrating an example of a domestic appliance communication system 800 that performs and provides the domestic appliance communications services and processes described herein. The domestic appliance communication system 800 can include any system capable of performing the processes described herein. For example, in the illustrated embodiment of FIG. 8, the domestic appliance communication system 800 communicates with one or more user computing devices 805 and one or more domestic appliances 806 (e.g., receptacle assembly 500 or any other embodiment such as any described elsewhere herein) over a network 860. In FIG. 8, the domestic appliance communication system 800 includes several components such as a domestic appliance monitoring module 810, a user alert module 820, and a user interface module 830. These components may also include further components that may not be depicted in FIG. 8. For example, domestic appliance communication system 800 can also include one or more servers, e.g., a web server, configured to receive status data from domestic appliances 806 (e.g., receptacle assembly 500 or any other embodiment such as any described elsewhere herein) and receive and respond to requests from the user computing devices 805.

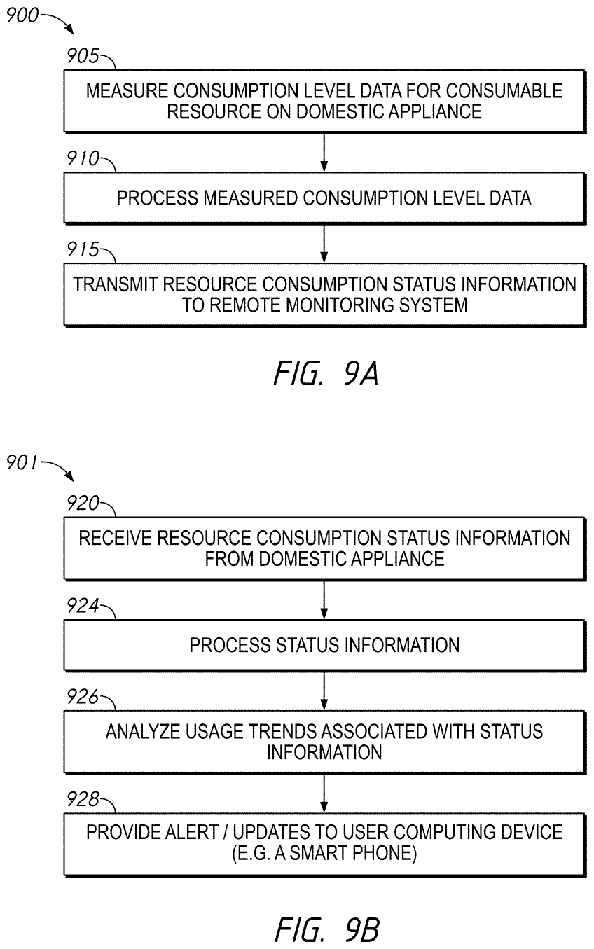

The domestic appliance monitoring module 810 may be configured to, for example, receive and process status information and other data from domestic appliances 806 (e.g., receptacle assembly 500 or any other embodiment such as any described elsewhere herein). In particular, the domestic appliance monitoring module 810 may be configured to execute various processes, such as the process 900 illustrated and described in more detail with reference to FIG. 9A herein. The domestic appliance monitoring module 810 may also be configured to store received status information and other data in appliance and usage data store 840 for later access, retrieval, and analysis as described further herein.

The user alert module 820 may be configured to, for example, provide alerts and other information, such as domestic appliance usage data, to user computing devices 805. In particular, the user alert module 820 may be configured to execute various processes, such as the process 901 illustrated and described in more detail with reference to FIG. 9B herein. For example, user alert module 820 may be configured to generate and/or send an alert or notification to a user computing device 805 when levels of a consumable resource (e.g., bag liners) on a domestic appliance (e.g., receptacle assembly 500 or any other embodiment such as any described elsewhere herein) are running low and/or projected to run out. User alert module 820 may also send an alert if no data has been received from a particular domestic appliance for some time (e.g., which may indicate that the user might need to check battery, send in the domestic appliance for repair, replace a malfunctioning sensor, etc.). Alerts may be delivered, for example, via any traditional communication (e.g., paper mail service) and/or via any electronic format or medium, such as electronic mail, text message (Short Message Service (SMS) or Multimedia Message Service (MMS)), instant messaging, in-application message, and so forth.

Alerts may be sent to user computing device 805 based on a variety of information and in response to different triggering events. In some embodiments the user alert module 820 may be configured to automatically convey or “push” updates to user computing device 805 as status information is received from domestic appliances 806 (e.g., receptacle assembly 500 or any other embodiment such as any described elsewhere herein). For example, when the domestic appliance communication system 100 receives an indication from a particular domestic appliance that a consumable resource is running low (e.g., at or below a pre-determined threshold amount that can be set by a consumer in some embodiments), the user alert module 850 may transmit a corresponding alert to the user computing device 805. In some embodiments, the user alert module 820 may add a refill or resource replacement item to a shopping list on behalf of the user, with or without notifying the user. The shopping list, for example, may then be provided or presented on demand by the user via user computing device 805, such as when the user is on his/her next shopping trip.

Alerts may also be sent or triggered, in whole or in part, in response to data received from user computing device 805, such as GPS coordinates or other location data. For example, GPS coordinates or location data may indicate that the user computing device 805 is at or near a location such as a supermarket or domestic goods retailer where a refill or replacement may be purchased. Responsive to making such a determination, user alert module 820 may send an alert, notification, or reminder message to the user computing device 805 to purchase the refill or replacement item from the nearby supermarket or retailer. In some embodiments, alerts may also include one or more coupons or targeted advertisements in relation to the needed refill or replacement item. In some embodiments, an alert may provide a purchase link which the user may select to purchase a household item such as a refill or replacement, for example from an electronic marketplace or retailer.

The user interface module 830 may be configured to construct or provide user interfaces of various types. One or more user interfaces may, in some embodiments, be provided in conjunction with alerts and other information provided by user alert module 820. In some embodiments, user interface module 830 constructs or provides web pages to be displayed in a web browser or computer/mobile application. The web pages may, in some embodiments, be specific to a type of device, such as a mobile device or a desktop web browser, to maximize usability for the particular device. In some embodiments, user interface module 830 may also interact with a client-side application, such as a mobile phone application (an “app”) or a standalone desktop application (that may be, for example, installed on a user computing device 805), and provide data to the application as necessary to display domestic appliance status information. In some embodiments, the domestic appliance communication system 800 may be a web-based system that may be accessed by users using an ordinary web browser.

Also shown in FIG. 8, a sample user computing device 805 may include a user interface (“UI”) module 807 which may be configured to execute some or all of the processes described herein. This may, for example, enable the user computing device 805 to present alerts and other data received from the domestic appliance communication system. The user interface module 807 may be configured to, for example, generate one or more user interfaces to provide domestic appliance status information and management options to the user of the device. In some embodiments, some or all of the user interfaces and/or UI elements may be generated either by the domestic appliance communication system 800 and provided to the user computing device 805, or they may be generated on the user computing device 805 via the user interface module 807, or in some combination thereof

User computing device 805 may be an end-user computing device that comprises one or more processors able to execute programmatic instructions and may comprise software and/or hardware that implement the user interface module 807. Examples of such a computing device 805 are a desktop computer workstation, a smart phone such as an Apple iPhone or an Android phone, a computer laptop, a tablet PC such as an iPad, Kindle, or Android tablet, a video game console, or any other device of a similar nature. In some embodiments, the user computing device 805 may comprise a touch screen that allows a user to communicate input to the device using their finger(s) or a stylus on a display screen. User computing device 805 may comprise storage systems such as a hard drive or memory, or comprise any other non-transitory data storage medium. The storage systems may be configured to store executable instructions that may be executed by one or more processors to perform computerized operations on the user computing device, accept data input from a user (e.g. on the touch screen), and/or provide output to a user using the display.

Also shown in FIG. 8, the domestic appliance communication system 800 may include and/or have access to one or more data stores or data sources including, for example, an appliance and usage data store 840. The usage data store 840 may include or store data for the domestic appliance communication system 800, such as status information or other data received from domestic appliances 806 (e.g., receptacle assembly 500 or any other embodiment such as any described elsewhere herein). For example, status information such as consumption and usage data for one or more domestic appliances 806 (e.g., receptacle assembly 500 or any other embodiment such as any described elsewhere herein) associated with a household or individual may be collected, stored, aggregated, and analyzed by the domestic appliance communication system 800 over time.

Domestic appliance communication system 800 may use the stored and/or otherwise analyzed usage data to identify or determine usage patterns, trends, preferences and the like that may be associated with particular domestic appliances associated with the household or individual. Such usage patterns may then be used by the domestic appliance communication system 800 to predict when a particular domestic appliance may need a refill or replacement of a consumable resource. For example, the bag liners in a receptacle may be filled and used on a regular basis, which may indicate a need for frequent refills on a predictable periodic basis.

Appliance and usage data store 840 may be of a particular benefit if, for example, a particular domestic appliance stops sending status information to the domestic appliance communication system 800 (e.g., if the domestic appliance experiences a technical failure, such as loss of power supply, loss of network connectivity, or the like). If status information has not been received from a particular domestic appliance for some defined or threshold period of time, the domestic appliance communication system 800 may nonetheless be able to predict that the domestic appliance may require replacement of a consumable by using data stored in usage data store 840. For example, domestic appliance communication system 800 may determine or predict that for a particular domestic appliance a consumable resource needs to be refilled or replaced once every 10 days. Based on this prediction, the domestic appliance communication system 800 may provide an alert on a periodic basis to the user that a refill may be needed regardless of whether actual or recent status information has been received from the domestic appliance. The domestic appliance communication system 800 may also be able to notify a user that the particular household appliance might be experiencing a technical failure and prompt the user to investigate and/or send the household appliance in for repair or replacement.

Predicting usage patterns may also be of benefit to the household or individual for purposes of planning a shopping trip. For example, a particular domestic appliance may not yet be running low on a consumable resource, but the domestic appliance communication system 800 may be able to predict when the domestic appliance will be low, based on past usage data patterns. The domestic appliance communication system 800 may then provide this information to the user, who may decide to buy a refill or replacement of the consumable resource on a future shopping trip (for example, the user may wish to have a refill readily available if the consumable resource is predicted to run out before the user's next planned shopping trip).

FIGS. 9A and 9B are logical flow diagrams for various embodiments of monitoring domestic appliance consumption and providing alerts to users. In some implementations, the routines are performed by embodiments of domestic appliance communications system 800 described with reference to FIG. 8 or by one of its components, such as the domestic appliance monitoring module 810, the user alert module 820, and/or the user interface module 830, and/or by embodiments of the domestic appliance 806 described above (e.g., any of the receptacle assemblies). The example scenarios are intended to illustrate, but not to limit, various aspects of the domestic appliance communications system 800 and/or domestic appliance 806 (e.g., receptacle assembly 500 or any other embodiment such as any described elsewhere herein). In some embodiments, the routines can be dynamic, with some procedures omitted and others added. In some embodiments, multiple instances of the routines may be occurring concurrently, for different domestic appliances and user computing devices.

FIG. 8A is a logical flow diagram of an embodiment of a process 900 for monitoring the status of a domestic appliance, involving a domestic appliance 806, e.g., receptacle assembly 500 or any other embodiment such as any described elsewhere herein. For ease of illustration the process 900 is described as being performed by receptacle assembly 500 or bag liner dispenser 504; however, the process 900 may be performed by any domestic appliance 806 configured to measure or otherwise monitor consumption levels of one or more consumable resources (e.g., a dispensed material, energy and/or space, etc.).

At block 905, the receptacle assembly 500 measures consumption level data for a consumable resource, for example bag liners, within the bag liner dispenser 504. The consumable resource may also or instead be a battery acting as a power supply. The bag liner dispenser 504 may be configured to measure the consumption level data on a periodic basis such as hourly, a number of times per day, and so on. To conserve energy, or depending on the frequency of use of the dispenser, the electric soap dispenser 106A may measure the consumption level data less frequently.

Measuring the consumption level data may be performed, for example, by activating the sensor 524 and determining the position of the biasing member 508, for example based on magnetic flux or the direction of the magnetic field such as is described in any example in this specification or otherwise.

At block 910, the domestic appliance 806 processes the measured consumption level data, for example to determine or estimate a used or remaining portion of the consumable resource. For example, as discussed above, the magnetic field or flux can be used to determine or estimate a remaining level number of bag liners in the bag liner dispenser 504.

At block 915, the receptacle assembly 500 transmits the resource consumption data to a remote monitoring system, such as the domestic appliance communications system 800. The data may be transmitted by the ECU 544 via an on-board network interface ship or logic circuitry. In some embodiments, the electric soap dispenser receptacle assembly 500 or bag liner dispenser 504 may be pre-configured with protocols and instructions used to communicate with a particular remote monitoring system over a cellular network. In some embodiments, the receptacle assembly 500 or bag liner dispenser 504 may be configured to communicate with a remote monitoring system over a broadband network, connecting to a home or local network as a bridge to the remote monitoring system. In some embodiments, an end user may be able to configure the receptacle assembly 500 or bag liner dispenser 504 to communicate with a desired remote monitoring system when the receptacle assembly 500 or bag liner dispenser 504 is initially setup.

The process 900 at blocks 905, 910, and 915 may be performed automatically by the receptacle assembly 500 or bag liner dispenser 504 on a periodic basis. The time period may be preconfigured, it may be user-defined, or it may be adapted over time by the receptacle assembly 500 or bag liner dispenser 504 itself based on the frequency of use of the device. For example, the receptacle assembly 500 or bag liner dispenser 504 may further be configured to maintain an internal counter corresponding to the number of bag liners used, and based on the internal counter reaching a certain number or repeating interval (e.g., every 10, 20, 50, etc. dispenses), trigger the process 900 to measure the consumption data as described above.

FIG. 9B is a logical flow diagram of an embodiment of a process 901 for providing domestic appliance status information remotely to a user computing device, involving a domestic appliance communication system. The process 901 may be performed, for example, by the receptacle assembly 500 or bag liner dispenser 504.

At block 920, domestic appliance communication system 800 receives, from a domestic appliance such as the receptacle assembly 500 or bag liner dispenser 504, resource consumption status information. The received resource consumption status information may include information identifying the domestic appliance, the type of consumable resource (or resources, if multiple) measured, and measurement data which may be raw or processed measurement data. The measurement data may indicate an amount or estimated amount used or remaining of each respective consumable resource (in either relative or absolute terms). For example, the domestic appliance communication system 800 may receive, from a receptacle assembly 500 or bag liner dispenser 504, status information indicating that an amount such as 5 bag liners remain in the bag liner dispenser 504, and/or status information indicating that a battery (or batteries) has (or have) approximately 50% remaining life before needing replacement or recharging.

At block 924, domestic appliance communication system 800 processes the received status information. For example, domestic appliance communication system 800 may use domestic appliance identifying information included with the received status information to look up the domestic appliance in a table stored on usage data store 840.

In some embodiments, domestic appliance communication system 800 may be configured to process raw or incomplete data received from the domestic appliance. For example, the domestic appliance communication system 800 may have access to additional product information (such as a total or maximum capacity of a bag liner dispenser 504) that may be used to further process status information. For example, a bag liner dispenser 504 may only transmit an amount of bag liners remaining in absolute terms (e.g., 2 bags), which the domestic appliance communication system 800 may then use in combination with an accessed or looked-up total capacity (e.g., 20 bags) to determine additional status information such as an approximate percentage remaining (e.g., 10%).

At block 926, domestic appliance communication system 800 may optionally analyze usage trends associated with the status information. For example, usage data 840 may be utilized to store and retrieve status information for a plurality of domestic appliances. As these data points are received and collected over time, the domestic appliance communication system 800 may analyze the data to determine usage trends, generate predictions for when certain consumable resources are projected to be depleted and require replacement or replenishment, and so on. These analyzed data trends and predictions may be used to inform the alerts sent to the consumer, as well as be presented to the consumer via one or more user interfaces.

At block 928, domestic appliance communication system 800 provides an alert and/or update to a computing device associated with the consumer to whom the domestic appliance belongs. Domestic appliance communication system 800 may use domestic appliance identifying information to look up or identify, using the usage data 840, a consumer associated with the device to whom an alert should be sent. The associated consumer information may also include associated delivery settings for the alert, such as a phone number, an email address, or other communication means (such as via an in-application alert that is to be presented via an application installed on the consumer's computing device). The alert may be provided to the consumer immediately or at any time once it has been received and processed by the system.

In some embodiments, domestic appliance communication system 800 provides the status information in response to a request received from the consumer. Such a request may be received, for example, when the consumer signs in to an account or app to view status information associated with his/her domestic appliances.

As mentioned elsewhere in this disclosure, domestic appliance communication system 800 may also provide additional information and options for the consumer, including coupons, advertisements, and/or user interfaces by which the consumer can manage his/her domestic appliances remotely.

In general, any of the structures, materials, features, routines, algorithms, processes, methods and/or criteria disclosed and/or illustrated herein for domestic appliance communications, monitoring, and/or processing of information, can be used individually or in combination with any of the other structures, materials, routines, algorithms, processes, methods or criteria disclosed and/or illustrated herein.

The domestic appliance communication system 800, domestic appliances 806 and/or user computing devices 805 may communicate directly or indirectly via a network 860. The computing device 805 may be connected to the network 860 may include any combination of networks, such as local area, wide area, Internet, etc., by way of a wired network, such as an Ethernet LAN or cable modem, or via a wireless method, such as through an 802.11 access point or via a cell phone network. The network 860 allows computing devices to send (i.e. transmit) and receive electronic transmissions.

In some embodiments, the domestic appliance communication system 800 may be configured differently, include different components or modules, and/or omit some components or modules shown in FIG. 8. For example, In some embodiments, domestic appliance communication system 800 includes one or more hardware processors in communication with a computer readable medium storing software modules including instructions that are executable by the one or more hardware processors, and one or more software modules. The one or more hardware processors may include, for example, digital logic circuitry. The one or more software modules may instruct a computing system to execute the various methods, approaches, and/or techniques as described herein.

As described above, the domestic appliance communication system 800 can be implemented by a computing system that includes one or more physical servers or other computing machines, such as several computing machines interconnected via a network. Thus, each of the components depicted in the domestic appliance communication system 800 can include hardware and/or software for performing various features. In some embodiments, the domestic appliance communication system 800 is implemented in association with a web site or collection of web sites. Various disclosed features can be incorporated into a mobile device operating system, a mobile application, a domestic appliance communication site or service, a social networking service, or any combination of these.

The domestic appliance communication system 800 can include one or more servers for receiving and responding to network requests from the user computing device(s) 805. The one or more servers can include web servers, application servers, database servers, combinations of the same, or the like. In some embodiments, the network 860 is a publicly accessible network of linked networks, possibly operated by various distinct parties, such as the Internet. In some embodiments, the network 860 may be a private network, such as, for example, a home or corporate network that is wholly or partially inaccessible to non-privileged users. In still other embodiments, the network 860 may include one or more private networks with access to and/or from the Internet. User computing devices 805 may be any type of personal computer or mobile computing device (such as a smart phone, tablet, electronic book reader, or any other type of portable computing device).

The processing of the various components of the domestic appliance communication system 100 can be distributed across multiple machines, networks, and other computing resources. The various components of the domestic appliance communication system 100 can also be implemented in one or more virtual machines, rather than in dedicated servers. Likewise, the data repositories shown can represent physical and/or logical data storage, including, for example, storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

In some embodiments, the domestic appliance communication system 100 may be configured differently than illustrated in the figures above. For example, various functionalities provided by the illustrated modules can be combined, rearranged, added, or deleted. In some embodiments, additional or different processors or modules may perform some or all of the functionalities described with reference to the example embodiment illustrated in the figures above. Many implementation variations are possible.

In some embodiments, the domestic appliance communication system 100 may be implemented on, or in communication with, one or more hosted computing environments. The hosted computing environments may include a collection of rapidly provisioned and released computing resources hosted in connection with the domestic appliance communication system 100. Such computing resources may be referred to, individually, as host computing devices. The computing resources may further include a number of computing, networking and storage devices in communication with one another. In some embodiments, the computing devices may correspond to physical computing devices. In some embodiments, the computing devices may correspond to virtual machine instances implemented by one or more physical computing devices. In some embodiments, computing devices may correspond to both virtual computing devices and physical computing devices. A hosted computing environment may also be referred to as a cloud computing environment.

Each of the processes, methods, and algorithms described in the preceding sections may be embodied in, and fully or partially automated by, code modules executed by one or more computers, computer processors, or machines configured to execute computer instructions. The code modules may be stored on any type of non-transitory computer readable medium or tangible computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non transitory computer storage such as, e.g., volatile or non-volatile storage.

Although certain embodiments of the bag liner dispenser have been described herein with respect to certain receptacle assemblies or interior containers, the bag liner dispensers described herein can be used with any of the receptacles or interior containers described herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The terms “about” and “substantially” as used herein represent an amount close to the stated amount that still performs a desired function or achieves a desired result. For example, in some but not all embodiments, as the context may permit, the terms “about” and “substantially” may refer to an amount that is within 10% of the stated amount.

The term “generally” as used herein represents a value, amount, or characteristic that predominantly includes or tends toward a particular value, amount, or characteristic. As an example, in certain embodiments, as the context may permit, the term “generally perpendicular” can refer to something that departs from exactly perpendicular by less than or equal to 20 degrees.

The ranges disclosed herein also encompass any and all overlap, sub-ranges, and combinations thereof. Language such as “up to,” “at least,” “greater than,” “less than,” “between” and the like includes the number recited. Numbers preceded by a term such as “about” or “approximately” include the recited numbers. For example, “about 5 mm” includes “5 mm.”

For expository purposes, the term “horizontal” as used herein is defined as a plane parallel to the plane or surface of the floor of the area in which the receptacle assembly or interior container being described is used or the method being described is performed, regardless of its orientation. The term “floor” can be interchanged with the term “ground.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the relative terms “front” and “rear” shall be defined from the perspective of the user opening the receptacle assembly when there is a lid portion. Thus, front refers to the direction of the receptacle closest to the user (e.g., the direction of the pedal or sensor), and rear refers to the direction of the receptacle furthest from the user (e.g., the direction of the connection between the lid portion and the body portion).

Although certain embodiments and examples have been described herein, it will be understood by those skilled in the art that many aspects of the receptacles and bag liner dispensers shown and described in the present disclosure may be differently combined and/or modified to form still further embodiments or acceptable examples. All such modifications and variations are intended to be included herein within the scope of this disclosure. A wide variety of designs and approaches are contemplated. No feature, structure, or step disclosed herein is essential or indispensable.

For purposes of this disclosure, certain aspects, advantages, and novel features are described herein. It is to be understood that not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Moreover, while illustrative embodiments have been described herein, the scope of any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to the examples described in the present specification or during the prosecution of the application, which examples are to be construed as non-exclusive. Further, the actions of the disclosed processes and methods may be modified in any manner, including by reordering actions and/or inserting additional actions and/or deleting actions. It is intended, therefore, that the specification and examples be considered as illustrative only, with a true scope and spirit being indicated by the claims and their full scope of equivalents.

The following is claimed:

1. A receptacle assembly comprising:
a body portion comprising a front wall, a rear wall, and lateral side walls connecting the front wall and the rear wall, the body portion further comprising an upper edge and a lower edge;
a bag liner dispenser configured to receive bag liners;
an opening that provides access to the bag liners when the bag liners are positioned in the bag liner dispenser;
an electronic controller;
a biasing member configured to urge the bag liners toward the opening when the bag liners are positioned in the bag liner dispenser;
a magnet; and
a sensor;
wherein the electronic controller is configured to provide information about the bag liners remaining in the bag liner dispenser by calculating a position of the biasing member by detecting one or more changes in or characteristics of a magnetic field emitted by the magnet based on relative movement or distance between the sensor and the magnet.

2. A combination of the receptacle assembly of claim 1 and the bag liners.

3. The receptacle assembly of claim 1, wherein the biasing member comprises a first bend.

4. The receptacle assembly of claim 3, wherein a middle portion of the first bend is closer to the rear wall of the body portion than the rear wall of a housing of the bag liner dispenser.

5. The receptacle assembly of claim 1, wherein the magnet is positioned in a recess of the biasing member.

6. The receptacle assembly of claim 1, wherein the biasing member is coupled to a rod, wherein the rod is coupled to a housing of the bag liner dispenser.

7. The receptacle assembly of claim 3, wherein the biasing member further comprises a second bend.

8. The receptacle assembly of claim 1, wherein the sensor is configured to generate a signal to enable the electronic controller to determine a number of bag liners within the bag liner dispenser.

9. A receptacle assembly comprising:
a receptacle body; and
a bag liner dispenser coupled to the receptacle body, the bag liner dispenser comprising:
a housing;
a biasing member positioned within the housing and rotatably coupled to a rod;
a magnet coupled to the biasing member; and
a sensor configured to detect one or more changes in the magnetic field based on a position of the biasing member.

10. The receptacle assembly of claim 9, wherein the biasing member comprises a first bend.

11. The receptacle assembly of claim 10, wherein a middle portion of the first bend is closer to a rear wall of the receptacle body than a rear wall of the housing of the bag liner dispenser.

12. The receptacle assembly of claim 9, wherein the magnet is positioned in a recess of the biasing member.

13. The receptacle assembly of claim 10, wherein the biasing member further comprises a second bend.

14. The receptacle assembly of claim 9, wherein a controller in electronic communication with the sensor is configured to determine a number of bag liners within the bag liner dispenser.

15. A receptacle assembly comprising:
a receptacle body;
a bag liner dispenser coupled to the receptacle body, the bag liner dispenser comprising:
a biasing member;
a magnet; and
a sensor;
an electronic control unit connected to the sensor and powered by a power supply, the electronic control unit configured to:
communicate with the sensor; and
determine, upon receiving a signal from the sensor, an estimated amount of liner bags remaining in the bag liner dispenser based at least in part on one or more characteristics of the magnetic field emitted by the magnet; and
a network communication device connected to the electronic control unit, the network communication device configured to transmit, to a computing system separate from the receptacle assembly, a notification providing information to a user about bag liners.

16. The receptacle assembly of claim 15, wherein the biasing member comprises a first bend.

17. The receptacle assembly of claim 16, wherein a middle portion of the first bend is closer to a rear wall of the receptacle body than a rear wall of a housing of the bag liner dispenser.

18. The receptacle assembly of claim 15, wherein the magnet is positioned in a recess of the biasing member.

19. The receptacle assembly of claim 15, wherein the biasing member is coupled to a rod, wherein the rod is coupled to a housing.

20. The receptacle assembly of claim 16, wherein the biasing member further comprises a second bend.

21. The receptacle assembly of claim 15, wherein the network communication device notifies a user to refill the bag liner dispenser.
